(19) United States
(12) Patent Application Publication
(10) Pub. No.: US 2022/0327336 A1
(43) Pub. Date: Oct. 13, 2022

(54) DETERMINING SIMILAR BEHAVIORAL PATTERN BETWEEN TIME SERIES DATA OBTAINED FROM MULTIPLE SENSORS AND CLUSTERING THEREOF

(71) Applicant: Tata Consultancy Services Limited, Mumbai (IN)

(72) Inventors: Tanushyam Chattopadhyay, Kolkata (IN); ABHISEK DAS, Kolkata (IN); PRATEEP MISRA, Kolkata (IN); SHUBHRANGSHU GHOSH, Kolkata (IN); SUVRA DUTTA, Kolkata (IN)

(73) Assignee: Tata Consultancy Services Limited, Mumbai (IN)

(21) Appl. No.: 17/368,584

(22) Filed: Jul. 6, 2021

(30) Foreign Application Priority Data
Mar. 3, 2021 (IN) 202121008969

(51) Int. Cl. G06K 9/62

(52) U.S. Cl. CPC G06K 9/6292; G06K 9/6221; G06K 9/6231; G06K 9/6215; G06K 9/6232

(57) ABSTRACT

Industries deploy a plethora of sensors that are attached to a system or human being, respectively. Under multi-sensor environment scenarios, there is a need to detect which sensors are behaving similarly within a time span. Sensor values often vary in range of values yet depict similar time series characteristic and sometimes have a phase difference in operation, thus making it impossible to detect such sensor similarity in a large system where the number of input parameters/sensor observations. Systems and methods of the present disclosure determine similar behavioral pattern between time series data obtained from multiple sensors and cluster the sensors. The system implements a pattern recognition-based approach to find the similarity and then applies a Dynamic Programming-based approach to detect similarity in at least two time series data and cluster the sensors and corresponding time series data into specific cluster(s).

### PRIORITY CLAIM

This U.S. patent application claims priority under 35 U.S.C. § 119 to: India Application No. 202121008969, filed on Mar. 3, 2021. The entire contents of the aforementioned application are incorporated herein by reference.

### TECHNICAL FIELD

The disclosure herein generally relates to sensor analysis, and, more particularly, to determining similar behavioral pattern between time series data obtained from multiple sensors and clustering thereof.

### BACKGROUND

In manufacturing, such as telemetry, energy, utility, and health care industries, a plethora of sensors are normally attached to a system or human being, respectively. In the last few years, a trend has been observed to apply data analytics on those time series data to get actionable insight. Any such system aims to get the time series and then apply descriptive, predictive, or prognostic analytics to fetch insight to far sight from the data. But in traditional machine learning (ML) based approaches one important aspect is to analyze the feature or the characteristic of the data. In classical approach, feature engineering involves discovering the feature dependency. Similarly, under the scenario of multi-sensor environment there is a need to detect which sensors are behaving similarly within a time span. Moreover, it is not possible for a single domain expert to detect such sensor similarity in a large system where the number of input parameters/sensor observations are in nearly in the order of 10³. Over and above, the sensor values often vary in different range of values yet depict similar time series characteristic and sometimes the sensors have a phase difference in operation.

### SUMMARY

Embodiments of the present disclosure present technological improvements as solutions to one or more of the above-mentioned technical problems recognized by the inventors in conventional systems. For example, in one aspect, there is provided a processor implemented method for determining similar behavioral pattern between time series data obtained from multiple sensors and clustering thereof. The method comprises assigning, via the one or more hardware processors, an alphanumeric code to each observation property of each sensor from a plurality of sensors, based on a plurality of quantized values to obtain a plurality of alphanumeric strings, wherein each of the plurality of sensors being associated with a corresponding time series data; performing, a dynamic programming technique executed by the one or more hardware processors, across the plurality of alphanumeric strings to identify a set of sensors having similar time series pattern; constructing, via the one or more hardware processors, a sparse matrix based on the set of sensors having similar time series pattern; computing, via the one or more hardware processors, a similarity score for the set of sensors using an edit distance technique; updating, via the one or more hardware processors, the sparse matrix with the similarity score for each pair of sensors in the set of sensors corresponding to the sparse matrix; and clustering, via the one or more hardware processors, the plurality of sensors into one or more clusters based on a comparison of (i) the similarity score of each pair of sensors with (ii) a threshold.

In an embodiment, the step of clustering comprises identifying two or more sensors from the plurality of sensors based on a dependency factor and clustering the two or more sensors into a specific cluster.

In an embodiment, the two or more sensors are identified using a search technique.

In an embodiment, the threshold is a pre-defined threshold or an empirically determined threshold.

In an embodiment, the step of assigning an alphanumeric code to each observation property of each sensor from a plurality of sensors comprises: obtaining a plurality of time series data from the plurality of sensors; computing a first order derivative over time using the obtained plurality of time series data; computing a gradient of change in value of the plurality of sensors over time based on the first order derivative; deriving an angle of change in direction based on the gradient of change in value of the plurality of sensors over time, and converting the derived angle to a measurement unit; and quantizing each time series data of the plurality of time series data into a plurality of bins based on the measurement unit to obtain the plurality of alphanumeric strings, each of the plurality of bins corresponds to a quantized value.

In another aspect, there is provided a system for determining similar behavioral pattern between time series data obtained from multiple sensors and clustering thereof. The system comprises a memory storing instructions; one or more communication interfaces; and one or more hardware processors coupled to the memory via the one or more communication interfaces, wherein the one or more hardware processors are configured by the instructions to: assign an alphanumeric code to each observation property of each sensor from a plurality of sensors, based on a plurality of quantized values to obtain a plurality of alphanumeric strings, wherein each of the plurality of sensors being associated with a corresponding time series data; perform a dynamic programming technique across the plurality of alphanumeric strings to identify a set of sensors having similar time series pattern; construct a sparse matrix based on the set of sensors having similar time series pattern; compute a similarity score for the set of sensors using an edit distance technique; update the sparse matrix with the similarity score for each pair of sensors in the set of sensors corresponding to the sparse matrix; and cluster the plurality of sensors into one or more clusters based on a comparison of (i) the similarity score of each pair of sensors with (ii) a threshold.

In an embodiment, the plurality of sensors is clustered into one or more clusters by identifying two or more sensors from the plurality of sensors based on a dependency factor and clustering the two or more sensors into a specific cluster.

In an embodiment, the two or more sensors are identified using a search technique.

In an embodiment, the threshold is a pre-defined threshold or an empirically determined threshold.

In an embodiment, the alphanumeric code is assigned to each observation property of each sensor from a plurality of sensors by obtaining the plurality of time series data from the plurality of sensors; computing a first order derivative over time using the obtained plurality of time series data; computing a gradient of change in value of the plurality of sensors over time based on the first order derivative; deriving an angle of change in direction based on the gradient of change in value of the plurality of sensors over time, and converting the derived angle to a measurement unit; and quantizing each time series data of the plurality of time series data into a plurality of bins based on the measurement unit to obtain the plurality of alphanumeric strings, each of the plurality of bins corresponds to a quantized value.

In yet another aspect, there are provided one or more non-transitory machine readable information storage mediums comprising one or more instructions which when executed by one or more hardware processors causes a method for determining similar behavioral pattern between time series data obtained from multiple sensors and clustering thereof by: assigning an alphanumeric code to each observation property of each sensor from a plurality of sensors, based on a plurality of quantized values to obtain a plurality of alphanumeric strings, wherein each of the plurality of sensors being associated with a corresponding time series data; performing a dynamic programming technique across the plurality of alphanumeric strings to identify a set of sensors having similar time series pattern; constructing a sparse matrix based on the set of sensors having similar time series pattern; computing a similarity score for the set of sensors using an edit distance technique; updating the sparse matrix with the similarity score for each pair of sensors in the set of sensors corresponding to the sparse matrix; and clustering the plurality of sensors into one or more clusters based on a comparison of (i) the similarity score of each pair of sensors with (ii) a threshold.

In an embodiment, the step of clustering comprises identifying two or more sensors from the plurality of sensors based on a dependency factor and clustering the two or more sensors into a specific cluster.

In an embodiment, the two or more sensors are identified using a search technique.

In an embodiment, the threshold is a pre-defined threshold or an empirically determined threshold.

In an embodiment, the step of assigning an alphanumeric code to each observation property of each sensor from a plurality of sensors comprises: obtaining a plurality of time series data from the plurality of sensors; computing a first order derivative over time using the obtained plurality of time series data; computing a gradient of change in value of the plurality of sensors over time based on the first order derivative; deriving an angle of change in direction based on the gradient of change in value of the plurality of sensors over time, and converting the derived angle to a measurement unit; and quantizing each time series data of the plurality of time series data into a plurality of bins based on the measurement unit to obtain the plurality of alphanumeric strings, each of the plurality of bins corresponds to a quantized value.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 depicts a system for determining similar behavioral pattern between time series data obtained from multiple sensors and clustering thereof, in accordance with an embodiment of the present disclosure.

FIG. 2 depicts an exemplary flow chart illustrating a method for determining similar behavioral pattern between time series data obtained from multiple sensors and clustering thereof, using the system of FIG. 1, in accordance with an embodiment of the present disclosure.

FIG. 3 depicts a graphical representation illustrating clustering of a first sensor S1 and a second sensor S2 and corresponding time series data into specific cluster, in accordance with an embodiment of the present disclosure.

FIG. 4 depicts a graphical representation illustrating clustering of a third sensor S3, a fourth sensor S4, a fifth sensor S5, a sixth sensor S6, a seventh sensor S7 and corresponding time series data into another specific cluster, in accordance with an embodiment of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

In manufacturing, various industries deploy a plethora of sensors wherein these sensors are normally attached to a system or human being, respectively. Any such system aims to get the time series and then apply descriptive, predictive, or prognostic analytics to fetch insight to far sight from the data. But in traditional machine learning (ML) based approaches one important aspect is to analyze the feature or the characteristic of the data. In classical approach, feature engineering involves discovering the feature dependency. Similarly, under the scenario of multi-sensor environment there is a need to detect which sensors are behaving similarly within a time span. Moreover, it is not possible for a single domain expert to detect such sensor similarity in a large system where the number of input parameters/sensor observations are in nearly in the order of 10³. Over and above, the sensor values often vary in different range of values yet depict similar time series characteristic and sometimes the sensors have a phase difference in operation. Conventional methods such as (i) Brute force-based method to plot pair wise time series graphs and get manual intervention to detect the similarity, (ii) Dendrogram based approach to find the sensor similarity wherein it fails when similar pattern is observed but the amplitude of the sensor observations is residing in different scale of values. But even in a multi-disciplinary analysis, sometimes these types of dependencies are being overlooked by any domain expert. Embodiments of the present disclosure provide systems and methods for determining similar behavioral pattern between time series data obtained from multiple sensors and clustering thereof. More specifically, system of the present disclosure implements a pattern recognition-based approach to find the similarity and then applies a Dynamic Programming (DP) based approach to detect the similarity in at least two time series data even when the time series data are out of phase and then cluster the sensors and corresponding time series data from various sensors into specific cluster(s). By implementing the DP based approach, the system proves to be computationally efficient, and makes the system highly scalable.

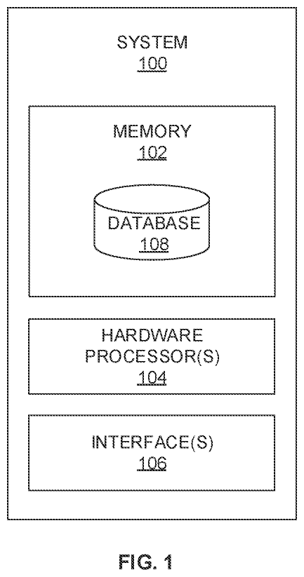

Referring now to the drawings, and more particularly to FIG. 1 through 4, where similar reference characters denote corresponding features consistently throughout the figures, there are shown preferred embodiments and these embodiments are described in the context of the following exemplary system and/or method.

FIG. 1 depicts a system 100 for determining similar behavioral pattern between time series data obtained from multiple sensors and clustering thereof, in accordance with an embodiment of the present disclosure. In an embodiment, the system 100 includes one or more hardware processors 104, communication interface device(s) or input/output (I/O) interface(s) 106 (also referred as interface(s)), and one or more data storage devices or memory 102 operatively coupled to the one or more hardware processors 104. The one or more processors 104 may be one or more software processing components and/or hardware processors. In an embodiment, the hardware processors can be implemented as one or more microprocessors, microcomputers, microcontrollers, digital signal processors, central processing units, state machines, logic circuitries, and/or any devices that manipulate signals based on operational instructions. Among other capabilities, the processor(s) is/are configured to fetch and execute computer-readable instructions stored in the memory. In an embodiment, the system 100 can be implemented in a variety of computing systems, such as laptop computers, notebooks, hand-held devices, workstations, mainframe computers, servers, a network cloud and the like.

The I/O interface device(s) 106 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface device(s) can include one or more ports for connecting a number of devices to one another or to another server.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, a database 108 is comprised in the memory 102, wherein the database 108 comprises one or more set of time series data captured by one or more sensors attached to various equipment/(or devices) deployed and being operated in an industry, or computing systems, or any other location. The database 108 further stores information on first order derivative over time being computed, gradient of change in value of the one or more sensors, derived angle of change in direction with associated measurement unit, details of alphanumeric codes assigned to each sensor or time-series data, set of sensors having similar time series pattern, sparse matrix, similarity score computed for the set of sensors, sensors and time-series data being clustered into one or more clusters.

The information stored in the database 108 further comprises various techniques such as edit distance technique as known in the art, depth first search (DFS) technique(s) as known in the art, and the like. The above-mentioned techniques comprised in the memory 102/database 108 are invoked as per the requirement by the system 100 to perform the methodologies described herein. The memory 102 further comprises (or may further comprise) information pertaining to input(s)/output(s) of each step performed by the systems and methods of the present disclosure. In other words, input(s) fed at each step and output(s) generated at each step are comprised in the memory 102 and can be utilized in further processing and analysis.

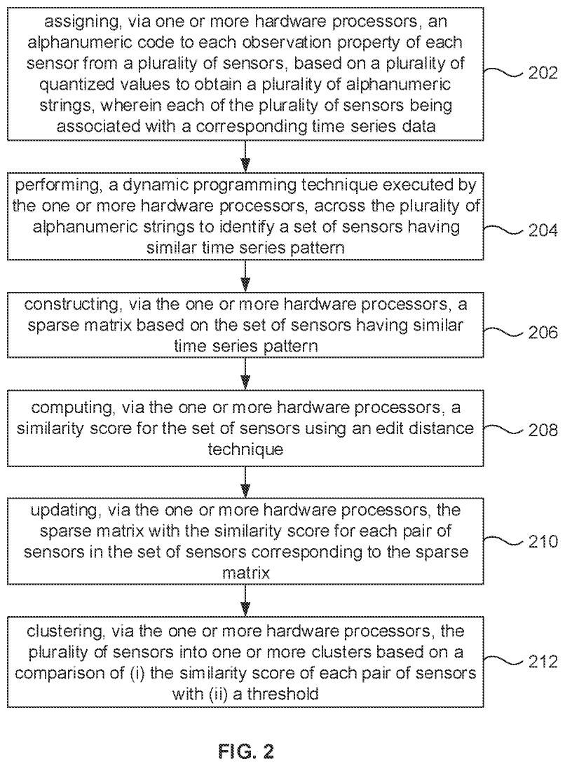

FIG. 2, with reference to FIG. 1, depicts an exemplary flow chart illustrating a method for determining similar behavioral pattern between time series data obtained from multiple sensors and clustering thereof, using the system 100 of FIG. 1, in accordance with an embodiment of the present disclosure. In an embodiment, the system(s) 100 comprises one or more data storage devices or the memory 102 operatively coupled to the one or more hardware processors 104 and is configured to store instructions for execution of steps of the method by the one or more processors 104. The steps of the method of the present disclosure will now be explained with reference to components of the system 100 of FIG. 1, and the flow diagram as depicted in FIG. 2. In an embodiment, at step 202 of the present disclosure, the one or more hardware processors 104 assign an alphanumeric code to each observation property of each sensor from a plurality of sensors, based on a plurality of quantized values to obtain a plurality of alphanumeric strings. Each of the plurality of sensors being associated with a corresponding time series data. The step of assigning an alphanumeric code to each observation property of each sensor comprises obtaining a plurality of time series data from the plurality of sensors; computing a first order derivative over time using the obtained plurality of time series data; computing a gradient of change in value of the plurality of sensors over time based on the first order derivative; deriving an angle of change in direction based on the gradient of change in value of the plurality of sensors over time, and converting the derived angle to a measurement unit; and quantizing each time series data of the plurality of time series data into a plurality of bins based on the measurement unit, each of the plurality of bins corresponds to a quantized value; and assigning the alphanumeric code to each observation property of each sensor from the plurality of sensors based on the plurality of bins. The step of assigning an alphanumeric code can be better understood by way of following description. At first a plurality of time series data is obtained from the plurality of sensors. In an embodiment, at step 202 of the present disclosure, the one or more hardware processors 104 obtain the plurality of time series data corresponding to one or more sensors attached to (or internally connected to) at least one computing device. In an embodiment, the at least one computing device is an Internet of Things (IoT) sensing device. Example of the IoT sensing device, includes but is not limited to, computer systems, mobile communication devices, routers, televisions, and the like. Example of time series data obtained from one or more (or various sensors) is depicted in below tables, Table 1 and 2, respectively.

TABLE 1

| Time stamp | Sensor S1 | Sensor S2 |
|---|---|---|
| 2205565.5 | 857483082.7 | 5448882986 |
| 2205565.5 | 901394976.4 | 6044886966 |
| 2205565.5 | 917497280.6 | 6143120101 |
| 2205565.5 | 952264031.6 | 6189056736 |
| 2205565.5 | 864257553.5 | 5567165024 |
| 2205565.5 | 950307149.8 | 6446396593 |
| 2205565.5 | 906683166.6 | 5859962840 |
| 2205565.5 | 892435483.2 | 5832552708 |
| 2205565.5 | 864422203.8 | 5683251237 |
| 2205565.5 | 909378630.6 | 6050415766 |
| 2205565.5 | 861532061.1 | 5719686291 |
| 2205565.5 | 884042423.8 | 5726315186 |
| 2205565.5 | 914984627 | 5964280917 |
| 2205565.5 | 918403145.1 | 6480776980 |
| 2205565.5 | 979584431 | 6907433507 |
| 2205565.5 | 1001604793 | 7208209871 |
| 2205565.5 | 0 | 0 |

TABLE 2

| Time | | | | | |
|---|---|---|---|---|---|
| stamp | Sensor S3 | Sensor S4 | Sensor S5 | Sensor S6 | Sensor S7 |
| 2205565.5 | 1119703257 | 192016000000 | 84152142029 | 1930630000000 | 13520524526 |
| 2205565.5 | 1188995789 | 236752000000 | 110406000000 | 1943820000000 | 14377517651 |
| 2205565.5 | 1473318876 | 246234000000 | 119408000000 | 2043830000000 | 16800453357 |
| 2205565.5 | 1089993303 | 243409000000 | 114980000000 | 1989840000000 | 16520986756 |
| 2205565.5 | 1093441412 | 219110000000 | 108854000000 | 1935490000000 | 12634714456 |
| 2205565.5 | 993463299.1 | 227225000000 | 108418000000 | 2193950000000 | 18477678534 |
| 2205565.5 | 965774693.6 | 256709000000 | 121117000000 | 2079380000000 | 16096967859 |
| 2205565.5 | 1165839852 | 248776000000 | 116476000000 | 2050930000000 | 16365850195 |
| 2205565.5 | 1127979425 | 211452000000 | 93861325888 | 1944550000000 | 14115130018 |
| 2205565.5 | 1043020178 | 239878000000 | 117994000000 | 1944280000000 | 13409192970 |
| 2205565.5 | 1214209203 | 231345000000 | 113282000000 | 1963690000000 | 15363492741 |
| 2205565.5 | 991292553.1 | 210511000000 | 102395000000 | 1972180000000 | 14314177384 |
| 2205565.5 | 1079854245 | 227805000000 | 112281000000 | 2011990000000 | 14319166719 |
| 2205565.5 | 1108564387 | 309277000000 | 139988000000 | 2259630000000 | 21124112176 |
| 2205565.5 | 1051742582 | 264806000000 | 123632000000 | 2050320000000 | 17120133027 |
| 2205565.5 | 1559544489 | 286944000000 | 143305000000 | 2334370000000 | 22263617116 |
| 2205565.5 | 0 | 274672000000 | 140524000000 | 2422180000000 | 25877879847 |

The sensors S1 and S2 corresponds to sensors values for as load_miss_completed_2M and load_miss_completed_4K respectively, wherein a load-miss refers to when a processor needing to fetch data from main memory, but data does not exist in the cache. Similar, sensor S3 corresponds to sensor values/time series data for ARITH_INST_RET_SCALAR (e.g., arithmetic instructions return scalar). For the sake of brevity, other sensors S3 through S7 are not specified or described. However, it is to be understood that these sensor names can be specified as mentioned for sensors S1 and S2 and such sensor listings shall not be construed as limiting the scope of the present disclosure. Once the above time series data is obtained from various sensors, a first order derivative over time is computed using the obtained plurality of time series data. The first order derivative is computed if the sensor records which stores the cumulative data as δs: δs=Sₙ−Sₙ₋₁ indicates the consumption of the physical property sensed by that specific sensor. The difference of sensor observation at the first two-time stamps is 43911893.65278. Hence the change in value is obtained by computing the difference in the sensor observation in two consecutive time stamps. Below tables Table 3 and 4 illustrate example of the first order derivative being computed over time using the obtained input time series data.

TABLE 3

| | First order derivative for | First order derivative for |
|---|---|---|
| Time stamp | sensor S1 | sensor S2 |
| 2205565.5 | 43911893.65 | 596003980.5 |
| 2205565.5 | 16102304.25 | 98233135 |
| 2205565.5 | 34766751 | 45936634.63 |
| 2205565.5 | −88006478.13 | −621891711.4 |
| 2205565.5 | 86049596.31 | 879231568.9 |
| 2205565.5 | −43623983.19 | −586433753.6 |
| 2205565.5 | −14247683.44 | −27410131.37 |
| 2205565.5 | −28013279.37 | −149301471.1 |
| 2205565.5 | 44956426.81 | 367164528.3 |
| 2205565.5 | −47846569.5 | −330729474.2 |
| 2205565.5 | 22510362.69 | 6628894.187 |
| 2205565.5 | 30942203.19 | 237965731.1 |
| 2205565.5 | 3418518.063 | 516496063.3 |
| 2205565.5 | 61181285.94 | 426656527.2 |
| 2205565.5 | 22020361.56 | 300776364 |
| 2205565.5 | −1001604793 | −7208209871 |

TABLE 4

| | First order | First order | First order | First order | First order |
|---|---|---|---|---|---|
| Time | derivative for | derivative for | derivative for | derivative for | derivative for |
| stamp | sensor S3 | sensor S4 | sensor S5 | sensor S6 | sensor S7 |
| 2205565.5 | 69292531.69 | 44736164017 | 26253701856 | 13185676712 | 856993124.4 |
| 2205565.5 | 284323087.2 | 9481577644 | 9002112375 | 100013777419 | 2422935706 |
| 2205565.5 | −383325572.5 | −2824663576 | −4428045337 | −53994813593 | −279466600.4 |
| 2205565.5 | 3448108.625 | −24299476485 | −6126280920 | −54351733515 | −3886272301 |
| 2205565.5 | −99978113 | 8115191562 | −435460994.2 | 258464267344 | 5842964079 |
| 2205565.5 | −27688605.5 | 29484661883 | 12698378674 | −114572573177 | −2380710676 |
| 2205565.5 | 200065158.7 | −7933124251 | −4640178939 | −28443436727 | 268882336.6 |
| 2205565.5 | −37860426.88 | −37324574438 | −22615042855 | −106387204202 | −2250720177 |
| 2205565.5 | −84959247.75 | 28426309551 | 24132908844 | −270190892.1 | −705937047.4 |
| 2205565.5 | 171189025.8 | −8533033585 | −4712227578 | 19412045786 | 1954299771 |
| 2205565.5 | −222916650.2 | −20834341271 | −10886511238 | 8492592692 | −1049315357 |
| 2205565.5 | 88561691.56 | 17294395073 | 9885822556 | 39812299903 | 4989335.563 |
| 2205565.5 | 28710141.87 | 81471529660 | 27706429444 | 247635034003 | 6804945457 |
| 2205565.5 | −56821804.37 | −44470618787 | −16355624387 | −209306656121 | −4003979149 |
| 2205565.5 | 507801906.8 | 22137862596 | 19672707670 | 284052183764 | 5143484089 |
| 2205565.5 | −1559544489 | −12271431316 | −2781283232 | 87807905075 | 3614262731 |

A gradient of change in value of the plurality of time series data associated with the one or more sensors over time is computed based on the first order derivative. In an embodiment, the gradient of change in the value is computed based on one or more parameters of the one or more sensors associated with the computing device (e.g., the computer system). The one or more parameters comprise, but are not limited to, time, and the like. For instance, a sensor associated with information on (or time series data associated with) memory consumption is considered, wherein parameters could be memory read/write instructions, number of read/write instructions at various time instances, time taken to execute read/write instructions, and the like. In such scenarios, the gradient of change in value of the plurality of time series data associated with the one or more sensors over time is computed based on a difference in time taken to execute read/write instructions, in one embodiment of the present disclosure. For example, the gradient of change in value of the plurality of time series data associated with the one or more sensors over time is computed between a first time instance (e.g., say at 4.10 PM—time taken to execute read/write instructions is ‘x’ seconds or milliseconds) and a second time instance (e.g., say at 4.15 PM—time taken to execute read/write instructions is ‘y’ seconds or milliseconds), wherein value of ‘x’ is one of greater than, equal to, or less than value of ‘y’. The gradient of change in value of the plurality of time series data associated with the one or more sensors over time is computed based on a change observed in memory consumption for read/write instructions, in another embodiment of the present disclosure. In case of other devices such as water pump, the gradient of change in the value is computed based on difference of diameter of the water pump and difference of time). In case of other IoT devices, such as an aerial vehicle (e.g., aircraft, drone, unmanned aerial, vehicles, and the like) the parameters of such vehicles include, altitude, GPS locations. Further example of devices includes land vehicles (e.g., a car). In such examples, parameters of the devices include, throttle position, torque, engine RPM. The gradient of change in the value is computed based on difference in throttle positions for each sensor and/or time instance.

Further, an angle of change in direction is derived based on the gradient of change in value of the plurality of sensors over time, and the derived angle is converted to a measurement unit. The above step is better understood by way of following description. If the first order difference is x and the time series data is sampled at every one unit of time, then the gradient also becomes x. As discussed above, now the theta is obtained as: theta=arc tan(x). Below Table 5 illustrates example of conversion of the derived angle to a measurement unit (e.g., theta):

TABLE 5

| | Measurement | | Measurement |
|---|---|---|---|
| 1st order Diff (or | unit (theta) for | 1st order Diff (or | unit (theta) for |
| derivative for S1 | S1 | derivative for S2 | S2 |
| 43911893.65 | 89.9999363 | 596003980.5 | 89.99999673 |
| 16102304.25 | 89.99982362 | 98233135 | 89.99997237 |
| 34766751 | 89.99991913 | 45936634.63 | 89.99993917 |
| −88006478.13 | −89.99996898 | −621891711.4 | −89.99999693 |
| 86049596.31 | 89.99996824 | 879231568.9 | 89.99999828 |
| −43623983.19 | −89.99993587 | −586433753.6 | −89.99999665 |
| −14247683.44 | −89.99980046 | −27410131.37 | −89.99989702 |
| −28013279.37 | −89.99989927 | −149301471.1 | −89.99998235 |
| 44956426.81 | 89.99993781 | 367164528.3 | 89.99999373 |
| −47846569.5 | −89.99994166 | −330729474.2 | −89.99999287 |
| 22510362.69 | 89.99987427 | 6628894.187 | 89.99956937 |
| 30942203.19 | 89.99990895 | 237965731.1 | 89.9999895 |
| 3418518.063 | 89.99916351 | 516496063.3 | 89.99999599 |
| 61181285.94 | 89.99995471 | 426656527.2 | 89.99999482 |
| 22020361.56 | 89.99987144 | 300776364 | 89.99999201 |
| −1001604793 | −89.99999868 | −7208209871 | −90.00000114 |

For the sake of brevity, theta or the measurement unit is not depicted for other sensors (S3 through S7). However, such depiction shall not be construed as limiting the scope of the present disclosure. Further, the one or more hardware processors 104 quantize the plurality of time series data into a plurality of bins based on the measurement unit to obtain a plurality of alphanumeric strings. Each bin from the plurality of bin is referred as an alphanumeric string. Each of the plurality of alphanumeric strings is tagged to or associated with a corresponding time series data (also referred as ‘sensor property’ or ‘sensor observation’ of the plurality of time series data obtained from corresponding sensors. Below Table 6 illustrates example of the plurality of bins obtained by quantizing the plurality of time series data based on the measurement unit (theta). Each of the plurality of bins corresponds to a quantized value. The expression ‘plurality of bins’ may be referred as ‘the plurality of alphanumeric codes’, or ‘code’ and interchangeably used herein.

TABLE 6

| Code | Code | Code | Code | Code | Code | Code | Code | Code | Code | Code | Code | Code |
|---|---|---|---|---|---|---|---|---|---|---|---|---|
| of | of | of | of | of | of | of | of | of | of | of | of | of |
| S1 | S2 | S3 | S4 | S5 | S6 | S7 | S8 | S9 | S10 | S11 | S12 | Sn |
| j | j | j | j | j | j | j | e | f | j | j | A | j |
| j | j | j | j | j | j | j | f | e | j | a | a | j |
| j | j | a | a | a | a | a | e | f | a | a | j | j |
| a | a | j | j | j | j | j | f | f | j | a | a | a |
| j | j | a | a | a | a | a | e | e | i | j | j | j |
| a | a | a | a | a | a | a | f | f | a | a | a | a |
| a | a | j | j | j | j | j | f | e | j | j | j | j |
| a | a | a | a | a | a | a | e | f | j | a | a | a |
| j | j | a | a | a | a | a | f | f | a | j | j | j |
| a | a | j | j | j | j | j | e | f | j | c | j | j |
| j | j | a | a | a | a | a | f | f | h | i | j | a |
| j | j | j | j | j | j | j | f | e | j | c | a | j |
| j | j | j | j | j | j | j | e | f | j | j | a | j |
| j | j | a | a | a | a | a | f | f | h | g | j | j |
| j | j | j | j | j | j | j | e | e | a | a | j | a |
| a | a | a | a | a | a | a | e | e | a | a | a | a |

The step of assigning the alphanumeric code to each sensor observation property from the plurality of sensors comprising the steps of (i) obtaining a plurality of time series data from the plurality of sensors; (ii) computing a first order derivative over time using the obtained plurality of time series data; (iii) computing a gradient of change in value of the plurality of sensors over time based on the first order derivative; (iv) deriving an angle of change in direction based on the gradient of change in value of the plurality of sensors over time, and converting the derived angle to a measurement unit; and (v) quantizing each time series data of the plurality of time series data into a plurality of bins based on the measurement unit to obtain a plurality of alphanumeric strings can be further referred from Applicant's patent specification titled ‘SYSTEMS AND METHODS FOR DETERMINING OCCURRENCE OF PATTERN OF INTEREST IN TIME SERIES DATA’ with application number 202121001728, filed on Jan. 13, 2021 with India Patent Office.

At step 204 of the present disclosure, the one or more hardware processors 104 perform a dynamic programming technique across the plurality of alphanumeric strings to identify a set of sensors having similar time series pattern. For instance, the plurality of alphanumeric strings of each sensor is compared with the plurality of alphanumeric strings obtained for other sensors. The comparison results in obtaining longest common subsequence (LCS) length between any 2 sensors across the sensors. The LCS length depicts the number of strings overlapping between the 2 sensors under consideration during comparison. Below table 7 depicts comparison of sensors for determining the set of sensors having similar time series pattern.

TABLE 7

| Sensor | Compared with | LCS length |
|---|---|---|
| Sensor S1 | Sensor S2 | 16 |
| Sensor S1 | Sensor S3 | 13 |
| Sensor S1 | Sensor S4 | 13 |
| Sensor S1 | Sensor S5 | 13 |
| Sensor S1 | . . . | |
| Sensor S1 | Sensor Sn | 14 |
| Sensor S2 | Sensor S3 | 13 |
| . . . | . . . | . . . |
| Sensor S2 | Sensor Sn | 14 |
| . . . | . . . | . . . |
| Sensor Sn | Sensor Sn-1 (or sensor | 12 |
| | Sm) | |

At step 206 of the present disclosure, the one or more hardware processors 104 construct a sparse matrix based on the set of sensors having similar time series pattern. In an embodiment, sparse matrix refers to a matrix that comprises values of LCS length. Below Table 8 illustrates an example of the sparse matrix:

TABLE 8

| | S1 | S2 | S3 | S4 | S5 | S6 | S7 | S8 | S9 | S10 | S11 | S12 | Sn |
|---|---|---|---|---|---|---|---|---|---|---|---|---|---|
| S1 | 0 | 16 | 0 | 0 | 0 | 0 | 0 | 0 | 0 | 0 | 0 | 0 | 0 |
| S2 | 0 | 0 | 0 | 0 | 0 | 0 | 0 | 0 | 0 | 0 | 0 | 0 | 0 |
| S3 | 0 | 0 | 0 | 16 | 16 | 16 | 16 | 0 | 0 | 0 | 0 | 0 | 0 |
| S4 | 0 | 0 | 0 | 0 | 16 | 16 | 16 | 0 | 0 | 0 | 0 | 0 | 0 |
| S5 | 0 | 0 | 0 | 0 | 0 | 16 | 16 | 0 | 0 | 0 | 0 | 0 | 0 |
| S6 | 0 | 0 | 0 | 0 | 0 | 0 | 16 | 0 | 0 | 0 | 0 | 0 | 0 |
| S7 | 0 | 0 | 0 | 0 | 0 | 0 | 0 | 0 | 0 | 0 | 0 | 0 | 0 |
| S8 | 0 | 0 | 0 | 0 | 0 | 0 | 0 | 0 | 0 | 0 | 0 | 0 | 0 |
| S9 | 0 | 0 | 0 | 0 | 0 | 0 | 0 | 0 | 0 | 0 | 0 | 0 | 0 |
| S10 | 0 | 0 | 0 | 0 | 0 | 0 | 0 | 0 | 0 | 0 | 0 | 0 | 0 |
| S11 | 0 | 0 | 0 | 0 | 0 | 0 | 0 | 0 | 0 | 0 | 0 | 0 | 0 |
| S12 | 0 | 0 | 0 | 0 | 0 | 0 | 0 | 0 | 0 | 0 | 0 | 0 | 0 |
| Sn | 0 | 0 | 0 | 0 | 0 | 0 | 0 | 0 | 0 | 0 | 0 | 0 | 0 |

At step 208 of the present disclosure, the one or more hardware processors 104 compute a similarity score for the set of sensors using an edit distance technique. At step 210 of the present disclosure, the one or more hardware processors 104 update the sparse matrix with the similarity score for each pair of sensors in the set of sensors corresponding to the sparse matrix. Below Table 9 illustrates an example of the updated sparse matrix with similarity score for each pair of the sensors in the set of sensors having similar time series pattern:

TABLE 9

| | S1 | S2 | S3 | S4 | S5 | S6 | S7 | S8 | S9 | S10 | S11 | S12 | Sn |
|---|---|---|---|---|---|---|---|---|---|---|---|---|---|
| S1 | 0 | 0.95 | 0 | 0 | 0 | 0 | 0 | 0 | 0 | 0 | 0 | 0 | 0 |
| S2 | 0 | 0 | 0 | 0 | 0 | 0 | 0 | 0 | 0 | 0 | 0 | 0 | 0 |
| S3 | 0 | 0 | 0 | 0.95 | 0.95 | 0.95 | 0.95 | 0 | 0 | 0 | 0 | 0 | 0 |
| S4 | 0 | 0 | 0 | 0 | 0.95 | 0.95 | 0.95 | 0 | 0 | 0 | 0 | 0 | 0 |
| S5 | 0 | 0 | 0 | 0 | 0 | 0.95 | 0.95 | 0 | 0 | 0 | 0 | 0 | 0 |
| S6 | 0 | 0 | 0 | 0 | 0 | 0 | 0.95 | 0 | 0 | 0 | 0 | 0 | 0 |
| S7 | 0 | 0 | 0 | 0 | 0 | 0 | 0 | 0 | 0 | 0 | 0 | 0 | 0 |
| S8 | 0 | 0 | 0 | 0 | 0 | 0 | 0 | 0 | 0 | 0 | 0 | 0 | 0 |
| S9 | 0 | 0 | 0 | 0 | 0 | 0 | 0 | 0 | 0 | 0 | 0 | 0 | 0 |
| S10 | 0 | 0 | 0 | 0 | 0 | 0 | 0 | 0 | 0 | 0 | 0 | 0 | 0 |
| S11 | 0 | 0 | 0 | 0 | 0 | 0 | 0 | 0 | 0 | 0 | 0 | 0 | 0 |
| S12 | 0 | 0 | 0 | 0 | 0 | 0 | 0 | 0 | 0 | 0 | 0 | 0 | 0 |
| Sn | 0 | 0 | 0 | 0 | 0 | 0 | 0 | 0 | 0 | 0 | 0 | 0 | 0 |

The steps 206 till 210 are better understood by way of the following description. A Dynamic programming-based approach (e.g., an optimum parenthesis) is performed across the plurality of alphanumeric strings to obtain the LCS between the strings of two different time series within a given span of time. Let the total time span under consideration be ‘m’ and the LCS of two time series data (TS) is ‘p’, then the matching/similarity score is defined as p*100/m. Two TS to be similar in nature if their similarity score is greater than a predefined threshold (τ) defined by the user. In one scenario of the present disclosure, τ=95% as described above in the updated sparse matrix. A highly sparse k×k matrix is obtained where k is the number of sensors. In one typical realization, a Levenshtein distance was used by embodiment of the present disclosure to compute the distance between two TS and determine the LCS length.

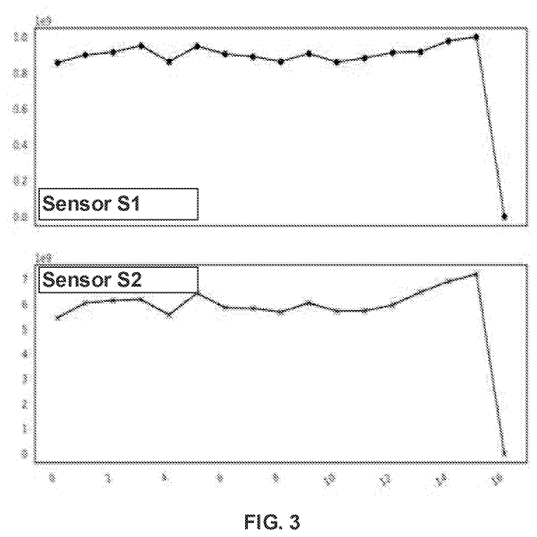

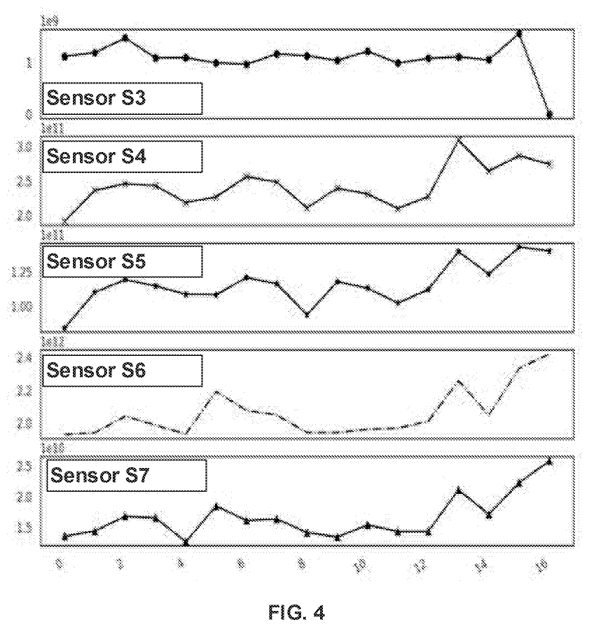

At step 212 of the present disclosure, the one or more hardware processors 104 cluster the plurality of sensors into one or more clusters based on a comparison of (i) the similarity score of each pair of sensors with (ii) a threshold. In an embodiment, the step of clustering comprises identifying two or more sensors from the plurality of sensors based on a dependency factor and clustering the two or more sensors into a specific cluster. Dependency factor for example, includes, which sensor is dependent on (or associated with) another sensor. Based on the above updated sparse matrix, it was observed that sensor S1 is having time series pattern similar to that of sensor S2. Therefore, sensors S1 and S2 were clustered into one group or cluster. However, it may be observed that sensor S3 had a time series data similar to that of the sensor S4. It was further observed that S4 had a dependency over sensor S5 and S5 had dependency over S6 and S6 over S7. Therefore, S3 is indirectly dependent on S7. Thus, sensors S3 through S7 may be clustered into one cluster (or group). In an embodiment, the threshold is a pre-defined threshold or an empirically determined threshold. For instance, threshold say, x% (e.g., 95%) of maximum possible rows present in a dataset (e.g., time series data). In other words, value of ‘x’ is configurable. Identification of the sensors for clustering is performed using a search technique, in one embodiment of the present disclosure. The search technique, in one example is a depth first search (DFS) technique. FIGS. 3 and 4, depict graphical representations illustrating clustering of sensors and corresponding time series data into specific clusters, in accordance with an embodiment of the present disclosure. More specifically, FIG. 3, with reference to FIGS. 1 through 2, depicts a graphical representation illustrating clustering of a first sensor S1 and a second sensor S2 and corresponding time series data into specific cluster, in accordance with an embodiment of the present disclosure. FIG. 4, with reference to FIGS. 1 through 3, depicts a graphical representation illustrating clustering of a third sensor S3, a fourth sensor S4, a fifth sensor S5, a sixth sensor S6, a seventh sensor S7 and corresponding time series data into another specific cluster, in accordance with an embodiment of the present disclosure. The step 212 and the graphical representations may be better understood by way of following description.

All the pairs of sensors that have a similarity score greater than equal to the pre-defined value of τ (or threshold as mentioned herein) are listed. A tuple of 3 entities, namely sensor pair identifiers (IDs) and the similarity score has been defined for each non-zero entry of the sparse matrix defined in the above steps. A tuple (Si, Sj) is defined to be connected if and only if (Si, Sj)>τ. A new label (λ) is assigned to each connected pair of sensors. The depth first search technique is applied to all the sensors to identify one or more sensors connected with sensor Si with the similar label λ. If (Si, Sj) and (Sj, Sk) are pair wise connected, then (Si, Sk) is defined to be connected and the same label is assigned to all of these sensors Si, Sj, and Sk, respectively, thus achieving clusters of sensors which have a similar pattern. It is to be understood by a person having ordinary skill in the art or person skilled in the art that example of a device (e.g., computer system) and its sensors (e.g., say sensor S1 through S7) as described herein shall not be construed as limiting the scope of the present disclosure, and the system and method of the present disclosure can be implemented in computing device that is capable of obtaining various sensor data or time series data of the sensors associated with the computing device.

Embodiment of the present disclosure provide system and method for determining similar behavioral pattern between time series data obtained from multiple sensors and clustering thereof, wherein the similarity among cluster of sensors is determined based on their patterns and not based on their values as human vision is more sensible to pattern than the values while comparing two graphs (e.g., refer graphical representations depicted in FIGS. 3 and 4). More specifically, present disclosure provides system and method for clustering the similar behaving sensors based on their pattern over time.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A processor implemented method, comprising:
assigning, via one or more hardware processors, an alphanumeric code to each observation property of each sensor from a plurality of sensors, based on a plurality of quantized values to obtain a plurality of alphanumeric strings, wherein each of the plurality of sensors being associated with a corresponding time series data;
performing, a dynamic programming technique executed by the one or more hardware processors, across the plurality of alphanumeric strings to identify a set of sensors having similar time series pattern;
constructing, via the one or more hardware processors, a sparse matrix based on the set of sensors having similar time series pattern;
computing, via the one or more hardware processors, a similarity score for the set of sensors using an edit distance technique;
updating, via the one or more hardware processors, the sparse matrix with the similarity score for each pair of sensors in the set of sensors corresponding to the sparse matrix; and
clustering, via the one or more hardware processors, the plurality of sensors into one or more clusters based on a comparison of (i) the similarity score of each pair of sensors with (ii) a threshold.

2. The processor implemented method of claim 1, wherein the step of clustering comprises identifying two or more sensors from the plurality of sensors based on a dependency factor and clustering the two or more sensors into a specific cluster.

3. The processor implemented method of claim 1, wherein the two or more sensors are identified using a search technique.

4. The processor implemented method of claim 1, wherein the threshold is a pre-defined threshold or an empirically determined threshold.

5. The processor implemented method of claim 1, wherein the step of assigning an alphanumeric code to each observation property of each sensor from a plurality of sensors comprises:
obtaining a plurality of time series data from the plurality of sensors;
computing a first order derivative over time using the obtained plurality of time series data;
computing a gradient of change in value of the plurality of sensors over time based on the first order derivative;
deriving an angle of change in direction based on the gradient of change in value of the plurality of sensors over time, and converting the derived angle to a measurement unit; and
quantizing each time series data of the plurality of time series data into a plurality of bins based on the measurement unit to obtain the plurality of alphanumeric strings, each of the plurality of bins corresponds to a quantized value.

6. A system, comprising:
a memory storing instructions;
one or more communication interfaces; and
one or more hardware processors coupled to the memory via the one or more communication interfaces, wherein the one or more hardware processors are configured by the instructions to:
assign an alphanumeric code to each observation property of each sensor from a plurality of sensors, based on a plurality of quantized values to obtain a plurality of alphanumeric strings, wherein each of the plurality of sensors being associated with a corresponding time series data;
perform a dynamic programming technique across the plurality of alphanumeric strings to identify a set of sensors having similar time series pattern;
construct a sparse matrix based on the set of sensors having similar time series pattern;
compute a similarity score for the set of sensors using an edit distance technique;
update the sparse matrix with the similarity score for each pair of sensors in the set of sensors corresponding to the sparse matrix; and
cluster the plurality of sensors into one or more clusters based on a comparison of (i) the similarity score of each pair of sensors with (ii) a threshold.

7. The system of claim 6, wherein the plurality of sensors is clustered into the one or more clusters by identifying two or more sensors from the plurality of sensors based on a dependency factor and clustering the two or more sensors into a specific cluster.

8. The system of claim 6, wherein the two or more sensors are identified using a search technique.

9. The system of claim 6, wherein the threshold is a pre-defined threshold or an empirically determined threshold.

10. The system of claim 6, wherein the alphanumeric code is assigned to each observation property of each sensor from the plurality of sensors comprises by:
obtaining the plurality of time series data from the plurality of sensors;
computing a first order derivative over time using the obtained plurality of time series data;
computing a gradient of change in value of the plurality of sensors over time based on the first order derivative;
deriving an angle of change in direction based on the gradient of change in value of the plurality of sensors over time, and converting the derived angle to a measurement unit; and
quantizing each time series data of the plurality of time series data into a plurality of bins based on the measurement unit to obtain the plurality of alphanumeric strings, each of the plurality of bins corresponds to a quantized value.

11. One or more non-transitory machine readable information storage mediums comprising one or more instructions which when executed by one or more hardware processors causes a method for determining similar behavioral pattern between time series data obtained from multiple sensors and clustering thereof by:
assigning an alphanumeric code to each observation property of each sensor from a plurality of sensors, based on a plurality of quantized values to obtain a plurality of alphanumeric strings, wherein each of the plurality of sensors being associated with a corresponding time series data;
performing a dynamic programming technique across the plurality of alphanumeric strings to identify a set of sensors having similar time series pattern;
constructing a sparse matrix based on the set of sensors having similar time series pattern;
computing a similarity score for the set of sensors using an edit distance technique;
updating the sparse matrix with the similarity score for each pair of sensors in the set of sensors corresponding to the sparse matrix; and
clustering the plurality of sensors into one or more clusters based on a comparison of (i) the similarity score of each pair of sensors with (ii) a threshold.

12. The one or more non-transitory machine readable information storage mediums of claim 11, wherein the step of clustering comprises identifying two or more sensors from the plurality of sensors based on a dependency factor and clustering the two or more sensors into a specific cluster.

13. The one or more non-transitory machine readable information storage mediums of claim 11, wherein the two or more sensors are identified using a search technique.

14. The one or more non-transitory machine readable information storage mediums of claim 11, wherein the threshold is a pre-defined threshold or an empirically determined threshold.

15. The one or more non-transitory machine readable information storage mediums of claim 11, wherein the step of assigning an alphanumeric code to each observation property of each sensor from a plurality of sensors comprises:
obtaining a plurality of time series data from the plurality of sensors;
computing a first order derivative over time using the obtained plurality of time series data;
computing a gradient of change in value of the plurality of sensors over time based on the first order derivative;
deriving an angle of change in direction based on the gradient of change in value of the plurality of sensors over time, and converting the derived angle to a measurement unit; and
quantizing each time series data of the plurality of time series data into a plurality of bins based on the measurement unit to obtain the plurality of alphanumeric strings, each of the plurality of bins corresponds to a quantized value.
